(19) United States
(12) Patent Application Publication
(10) Pub. No.: US 2025/0254537 A1
(43) Pub. Date: Aug. 7, 2025

(54) MANAGING NODE, NETWORK NODE, AND METHODS PERFORMED THEREIN FOR HANDLING A SERVICE COMPRISING FUNCTIONS DEPLOYED IN A COMMUNICATIONS NETWORK

(71) Applicant: Telefonaktiebolaget LM Ericsson (publ), Stockholm (SE)

(72) Inventors: Tomas MECKLIN, Ingå (FI); Timo SIMANAINEN, Veikkola (FI); Mukesh THAKUR, Espoo (FI); Tero KAUPPINEN, Espoo (FI)

(21) Appl. No.: 18/855,821

(22) PCT Filed: Apr. 29, 2022
(86) PCT No.: PCT/SE2022/050416

§ 371 Date: Oct. 10, 2024

(51) Int. Cl. H04W 24/02; H04L 41/082

(52) U.S. Cl. CPC H04W 24/02; H04L 41/082

(57) ABSTRACT

Embodiments herein relate, in some examples, to a method performed by a managing node for handling a service comprising functions deployed in a communication network. The managing node obtains an indication of a measured parameter related to communications between the functions; and triggers an updating of a deployment packaging of the functions based on the obtained indication.

### TECHNICAL FIELD

Embodiments herein relate to a managing node, a network node, and methods performed therein for communication networks. Furthermore, a computer program product and a computer readable storage medium are also provided herein. In particular, embodiments herein relate to handling a service comprising functions deployed in a communication network.

### BACKGROUND

In a typical communication network, user equipments (UE), also known as wireless communication devices, mobile stations, stations (STA) and/or wireless devices, communicate via a Radio Access Network (RAN) to one or more core networks (CN). The RAN covers a geographical area which is divided into service areas or cell areas, with each service area or cell area being served by a radio network node such as an access node, e.g., a Wi-Fi access point or a radio base station (RBS), which in some radio access technologies (RAT) may also be called, e.g., a NodeB, an evolved NodeB (eNB) and a gNodeB (gNB). The service area or cell area is a geographical area where radio coverage is provided by the radio network node. The radio network node operates on radio frequencies to communicate over an air interface with the UEs within range of the access node. The radio network node communicates over a downlink (DL) to the UE and the UE communicates over an uplink (UL) to the access node.

Media related sessions such as a gaming session, a media interactive session, a virtual reality session, or an augmented reality session, may today be handled in a cloud computing environment. In the example of gaming, a cloud gaming service enables users to play games requiring high compute resources on a client device that is not capable of running the game anyway, such as mobile phones, televisions, older laptops.

As systems are becoming increasingly distributed, there are tradeoffs that impact the characteristics and performance of a service comprising distributed functions in a cloud. These tradeoffs are particularly problematic for mission critical systems, such as communication and industrial systems.

Microservice architecture, described in 2014 in “Microservices—A definition of this new architectural term”, Martin Fowler, https://martinfowler.com/articles/microservices.html, described a dis-aggregated architecture, where systems are designed by using independently deployable microservices. Some aspects of microservice architecture can be found in earlier concepts used for example by enterprise solutions, Service Oriented Architecture (SOA). In 2015, Fowler published an article “Microservice Trade-off”, Martin Fowler, https://martinfowler.com/articles/microservice-trade-offs.html describing some of the tradeoffs with a microservice architecture. Some of these tradeoffs has been mitigated by automation, such as Netflix Nebula, https://github.com/nebula-plugins/gradle-dependency-lock-plugin that lock microservices to specific version of other microservices. Other tradeoffs from dis-aggregated architecture are solved by introducing automation in service life-cycle management and an increasing number of solutions for inter-service communication, such as gRPC https://grpc.io/, used by Google for their internal service communication. gRPC is a modern open source high performance remote procedure call (RPC) framework that can run in any environment. It can connect services in and across data centers.

5G is based on what is called Service-Based Architecture (SBA), using patterns from dis-aggregated architectures, much like microservices architecture. In SBA, services register themselves and subscribe to other services. Services may also organize into service chains, including multiple service functions.

In Network Functions Virtualisation (NFV) Release 4; Management and Orchestration; Requirements for service interfaces and object model for OS container management and orchestration specification, https://www.etsi.org/deliver/etsi_gs/NFV-IFA/001_099/040/04.01.01_60/gs_NFV-IFA040v040101p.pdf, the information model for Network Service Virtualization is described, see FIG. 1 that shows abstract NFV objects' relationships.

In FIG. 1, the relation between Managed Container Infrastructure Object (MCIO), operating system (OS) Containers, Virtual Network Functions (VNF), Virtual Network Function Components (VNFC) and a Connection Point (CP) is described. This information model is defined by the original European Telecommunications Standards Institute (ETSI) Management and Orchestration (MANO) reference architecture for microservices.

In https://github.com/nebula-plugins/gradle-dependency-lock-plugin, chapter 5.4.3 it is stated that “usage of Kubernetes as the de-facto implementation for microservice orchestration may have limited application in some contexts, as it may neither support fine-grained (down to the service instance level) location-aware lifecycle management or a (across locations) federated policy-driven SLA assurance approach”.

An evolution of the NFV is proposed, called Service Function Virtualization (SFV), described in FIG. 2 showing a Service Function Virtualization information model. This model describes the information model for service orchestration, packaging, and routing.

FIG. 3 shows a simplified example of deployment of a service and service chains, wherein FIG. 3 shows deployment options supporting vehicle original equipment manufacturer (OEM) cellular subscription. The User Plane Functions (UPF) in FIG. 3 may be deployed in a variety of ways. If the link between two UPFs traverses process, container, host, or network boundary, latencies will occur.

Similar use cases may use similar user plane function chains. For example, unmanned vehicle use cases use the same user plane functions in similar setup, independent of where and why the unmanned vehicles are flying. Such user plane function chains may be referred to as user plane profiles.

### SUMMARY

As part of developing embodiments herein one or more problems have been identified. A tradeoff from using a dis-aggregated architecture is that remote communications, also referred to as remote calls, between functions of a service may be slow and may fail, especially when the communications traverse the communication network. There are limited remedies for this tradeoff, due to the reasons explained herein. Tradeoffs that originate from the fact that communication is traversing container, cluster or domain boundaries are hard to mitigate. Serialization, inter-process communication (IPC), context switching, user/kernel space switching, input/output (IO) and others that are used for communication between execution components. These may be optimized to some extent, but these are still slower than communication within a compute context. Also, the IPC mechanisms crossing these boundaries will always require more resources than communication within a compute or process boundary.

An object of embodiments herein is to provide a mechanism for improving operations of a service in a communication network in an efficient manner.

According to an aspect the object may be achieved by providing a method performed by a managing node for handling a service comprising functions deployed in a communication network. The managing node obtains an indication of a measured parameter related to communications between the functions; and triggers an updating of a deployment packaging of the functions based on the obtained indication.

According to another aspect the object may be achieved by providing a method performed by a network node for handling a service comprising functions deployed in a communication network. The network node measures a parameter related to communications between the functions; and provides to a managing node, an indication of the measured parameter.

It is furthermore provided herein a computer program product comprising instructions, which, when executed on at least one processor, cause the at least one processor to carry out the methods above, as performed by the managing node and the network node, respectively. It is additionally provided herein a computer-readable storage medium, having stored thereon a computer program product comprising instructions which, when executed on at least one processor, cause the at least one processor to carry out the methods above, as performed by the managing node and the network node, respectively.

According to still another aspect the object may be achieved by providing a managing node for handling a service comprising functions deployed in a communication network. The managing node is configured to obtain an indication of a measured parameter related to communications between the functions; and to trigger an updating of a deployment packaging of the functions based on the obtained indication.

According to yet another aspect the object may be achieved by providing a network node for handling a service comprising functions deployed in a communication network. The network node is configured to measure a parameter related to communications between the functions; and to provide to a managing node, an indication of the measured parameter.

Embodiments herein propose a method for an optimized service execution. Since a deployment architecture is dependent on several parameters, such as use case, time of day, user profile, Service Level Agreement (SLA), the optimization may vary over time. Consequently, the deployment of functions of the service may be based on real-time knowledge of how the system behaves and which paths between functions within the system are the ones used the most. Embodiments herein address the updating of the deployment architecture, and not only how a service is managed during run-time. Current solutions focus on optimal placement, routing, registries, and/or service discovery. In contrast, embodiments herein use analytics regarding the communications between the functions of the service to optimize and specialize the way functions are packaging deployed. The deployed packaging may be different for different edge sites and systems as well as for different operators, time of day, and/or locations of a UE, and is based on the measured parameter analysed in embodiments herein.

Since the deployment packaging is updated accordingly, improved efficiency for operations of a service in a communication network is achieved.

### BRIEF DESCRIPTION OF THE DRAWINGS

Embodiments will now be described in more detail in relation to the enclosed drawings, in which:

FIG. 1 shows abstract NFV objects' relationships according to prior art;

FIG. 2 shows Service Function Virtualization information model according to prior art;

FIG. 3 shows deployment options supporting vehicle OEM cellular subscription according to prior art;

FIG. 4 shows a schematic overview depicting a communication network according to embodiments herein;

FIG. 5 shows a combined flowchart and signalling scheme according to embodiments herein;

FIG. 6 shows a schematic flowchart depicting a method performed by a managing node according to embodiments herein;

FIG. 7 shows a schematic flowchart depicting a method performed by a network node according to embodiments herein;

FIG. 8 shows a schematic flowchart depicting a method according to some embodiments herein;

FIG. 9 shows a schematic overview depicting components according to some embodiments herein;

FIG. 10 shows a schematic overview depicting node communication between separate hosts;

FIG. 11 shows a schematic overview depicting node communication with host co-location;

FIG. 12 shows a schematic overview depicting node communication with virtual host co-location;

FIG. 13 shows a schematic overview depicting node communication with cluster co-location;

FIG. 14 shows a schematic overview depicting remote calls in shared memory;

FIG. 15 shows a schematic overview depicting distributed services/functions;

FIG. 16 shows a schematic overview depicting POD co-location;

FIGS. 17a-17b show block diagrams depicting a managing node according to embodiments herein; and

FIGS. 18a-18b show block diagrams depicting a network node according to embodiments herein.

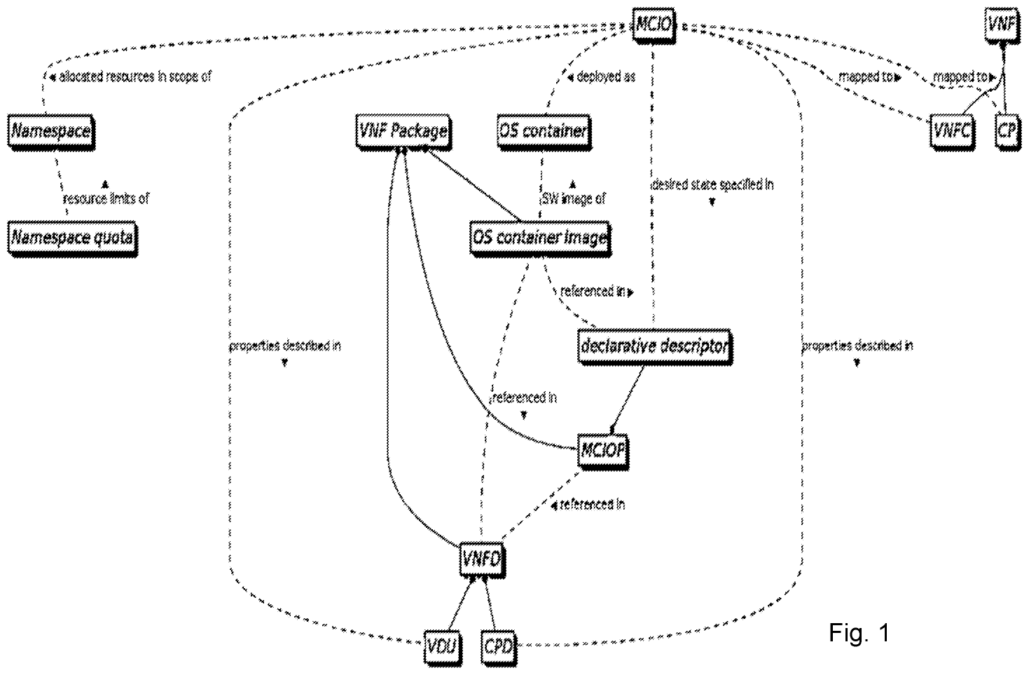

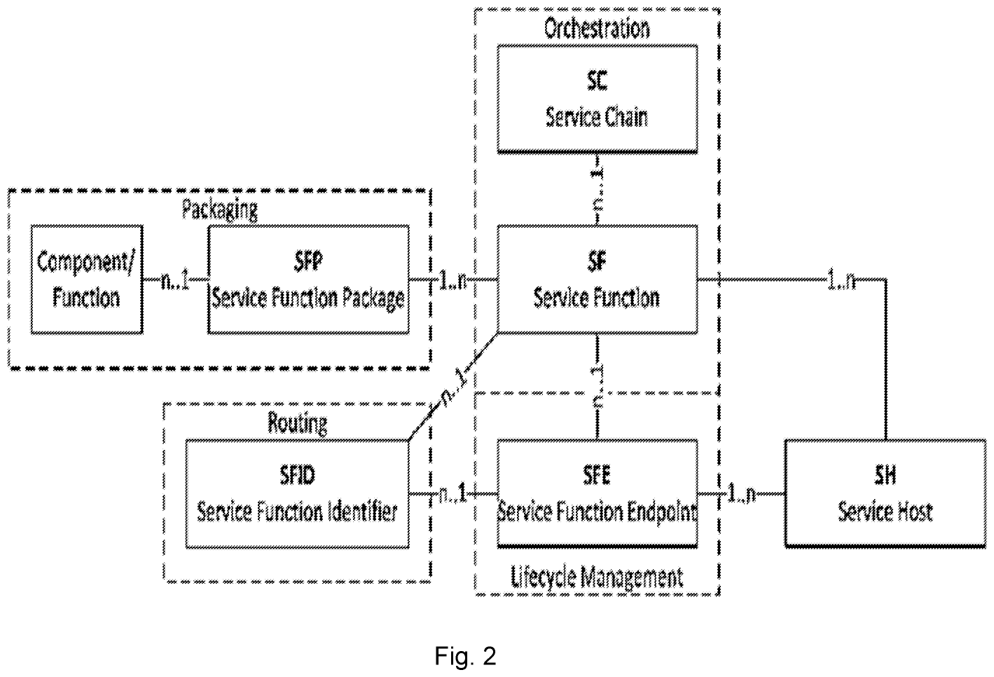

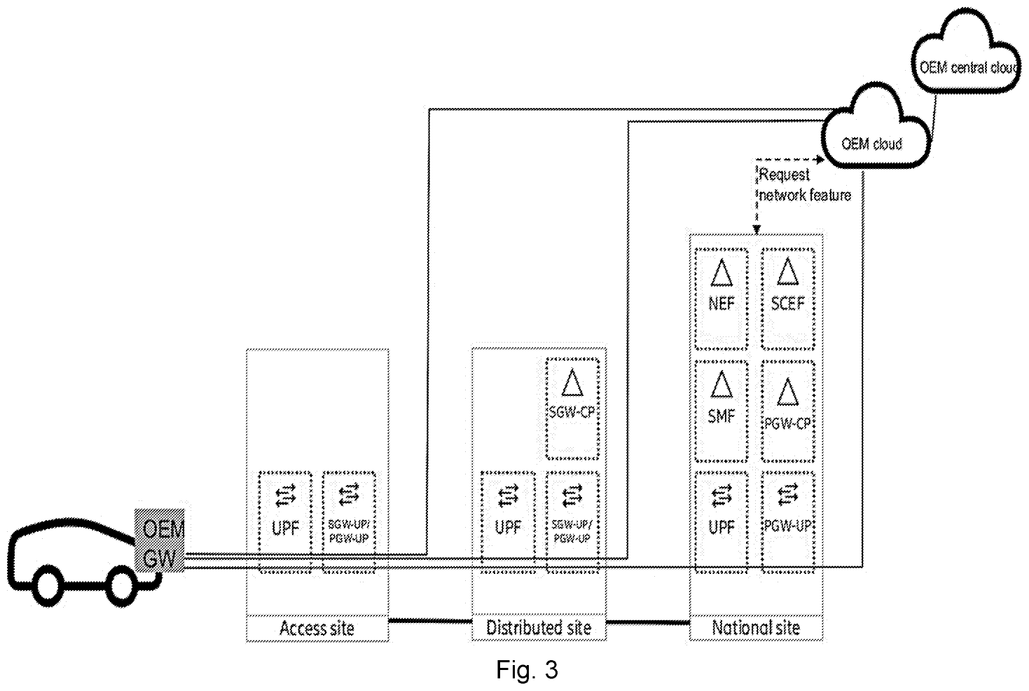

### DETAILED DESCRIPTION

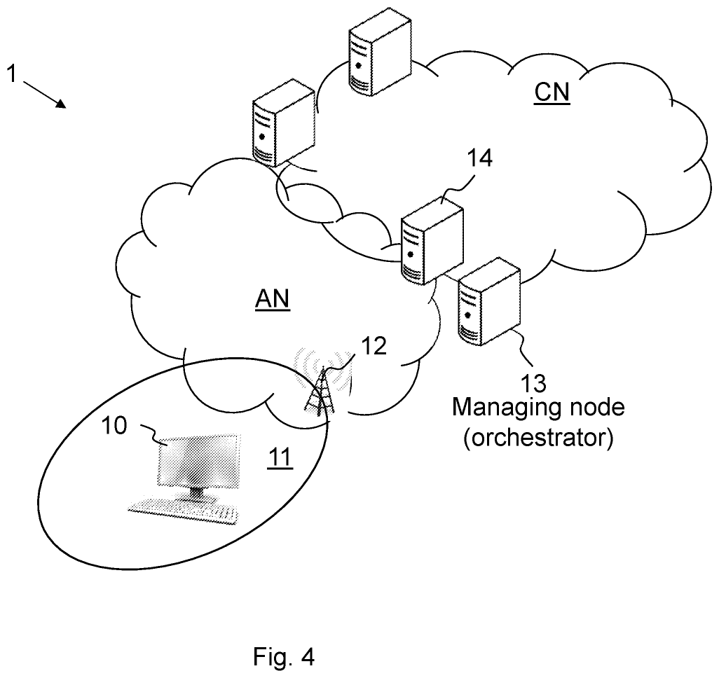

Embodiments herein relate to communication networks in general. FIG. 4 is a schematic overview depicting a communication network 1. The communication network 1 may be any kind of communication network such as a wired communication network and/or a wireless communication network comprising, e.g., a radio access network (RAN) and a core network (CN). The communication network may comprise logical processing units such as a servers or server farms providing compute capacity and may comprise a cloud environment comprising compute capacity in one or more clouds. The communication network 1 may use one or a number of different technologies, such as packet communication, Wi-Fi, Long Term Evolution (LTE), LTE-Advanced, Fifth Generation (5G), NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

In the communication network 1, devices, e.g., a user equipment 10 such as a computer or a wireless communication device, for example, a wireless device such as a mobile station, a non-access point (non-AP) station (STA), a STA, and/or a wireless terminal, communicate via one or more Access Networks (AN), e.g., RAN, to one or more core networks (CN). It should be understood by the skilled in the art that “user equipment” is a non-limiting term which means any terminal, wireless communication terminal, user equipment, Machine Type Communication (MTC) device, Device to Device (D2D) terminal, internet of things (IoT) operable device, or node e.g. smart phone, laptop, mobile phone, sensor, relay, mobile tablets or even a small base station capable of communicating using radio communication with a network node within an area served by the network node. In case the AN is a RAN the communication network 1 may comprise a radio network node 12 providing, e.g., radio coverage over a geographical area, a service area, or a first cell 11, of a radio access technology (RAT), such as NR, LTE, Wi-Fi, WiMAX or similar. The radio network node 12 may be a transmission and reception point, a computational server, a base station e.g. a network node such as a satellite, a Wireless Local Area Network (WLAN) access point or an Access Point Station (AP STA), an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point or any other network unit or node depending e.g.

on the radio access technology and terminology used. The radio network node 12 may be referred to as a serving network node wherein the service area, e.g. the first cell 11, may be referred to as a serving cell or primary cell, and the serving network node communicates with the UE 10 in form of DL transmissions to the UE 10 and UL transmissions from the UE 10.

According to embodiments herein the UE 10 may use a service such a real-time related service, for example, a managing vehicles application or a media related application such as streaming media application. The service comprises functions dis-aggregated over servers in the communication network 1. The functions may additionally or alternatively be referred to as microservices, micro functions, components, subservices, modules, and/or subfunctions. The functions may be running on e.g., docker containers, PODs or virtual machines comprised in a general purpose servers or physical instantiations of servers that may form a cloud environment that may be part of the communication network 1. A POD may e.g. be smallest deployable units of computing that may be created and/or managed in some frameworks, e.g. Kubernetes.

The communication network 1 further comprises a managing node 13 such as an orchestrator, for example, a MANO node orchestrating the functions of the service in the communication network. The managing node 13 may be a physical node or a virtualized component running on a general-purpose server.

The communication network 1 further comprises a network node 14 for analysing usage of the functions and/or the communication network 1. The network node 14 may be configured to analyse a behaviour of the system, e.g. metrics in relation to the functions, end to end, and may be referred to as a part of an automated packaging and deployment (APAD) function and may also comprise the managing node 13. The network node 14 may be configured to make decisions about what would be an optimal deployment strategy for a chain of functions. Once the network node 14, for example in telco systems operations support system (OSS), detects that a specific function chain and user plane profile is used in relatively many cases, for example, above a threshold, the managing node 13 may instruct a re-structuring packaging of the functions, also referred to as containerization, so that the detected used functions and user plane functions are co-located within a same execution component, such as containers or VMs, or PODs, i.e., a packaging deployment using a shared memory space. Doing that, all remote calls between these services will be done within the same execution context and consequently use less resources and speed up execution.

According to embodiments herein, the network node 14 measures a parameter related to communications between the functions of the service. The parameter may indicate a traffic intensity or a communication cost. As an example, the parameter measured may comprise a frequency of communications between at least two functions of the service.

The network node 14 further provides, for example, transmits, to the managing node 13, an indication of the measured parameter. The indication may comprise a value, an index or a flag indicating a measured value of the parameter. Thus, the managing node 14 obtains the indication of the measured parameter and then triggers an updating of a deployment packaging of the functions based on the obtained indication. For example, the managing node 13 may determine co-location and/or separation of functions based on the measured parameter and may then, e.g., order an updating of the deployment packaging from a deployment node, which order is based on the measured parameter; or may execute the deployment packaging itself as determined.

As an example, when the network node 14 detects and indicates that a function ‘a’ and function ‘c’ in a service are communicating heavily during execution of the service at the UE 10, the managing node 13 may receive the indication and instruct an execution function such as a Continuous Integration/Continuous Deployment (CI/CD), to update the deployment packaging to co-locate functions ‘a’ and ‘c’ to a processing resource sharing a same memory space.

Thus, embodiments herein deploy functions in an efficient manner resulting in an optimized solution of the providing the service. Co-locating functions, as in locating execution (run-time) components network-, compute- and storage-wise close to each other, reduces traffic over the communication network as compared to separated functions. An internal network has significantly higher throughput and lower latency than using the communication network. Decreasing latency and increasing throughput will lead to a shorter response time. Decreasing the amount of traffic in the communication network 1 will affect all entities connected to the communication network 1. This solution might further save money, since the communication network 1 is potentially the bottleneck that sets the maximum performance of the system and embodiments herein reduces a need for network capacity. By decreasing the needed network capacity, the systems and nodes in the communication network 1 may achieve a significant performance increase. Co-locating related functions decreases the need to have data records shared between multiple executing entities. Sharing may cause locking of resources and requires synchronization which causes a significant performance penalty. On the other hand, co-locating instead of sharing related functions requires sharing more system resources such as memory and CPU. Embodiments herein may select which functions to co-locate and which are better to run separately. This achieves advantages of both approaches. There is no need to put all the functions in the same execution context, but functions may be packaged in a way that gain most advantage. By co-locating selected functionality, the increase in performance may be optimized.

Pros of co-locating runtime functions of one packaging deployment:
Less network traffic between the runtime functions, thus less network load,
Smaller round-trip times for remote calls between co-located functions,
No need for encryption of inter-component traffic (remote calls) if a secure execution context is provided, and
Data sharing through common memory space, less context switching.

Cons of co-locating functions in one execution component:
The compute resource requirement of that execution component will increase.

Embodiments herein use analytics regarding the communications between the functions of the service to optimize and specialize the way functions are packaging deployed. This achieves a solution which improves operations of a service in a communication network in an efficient manner.

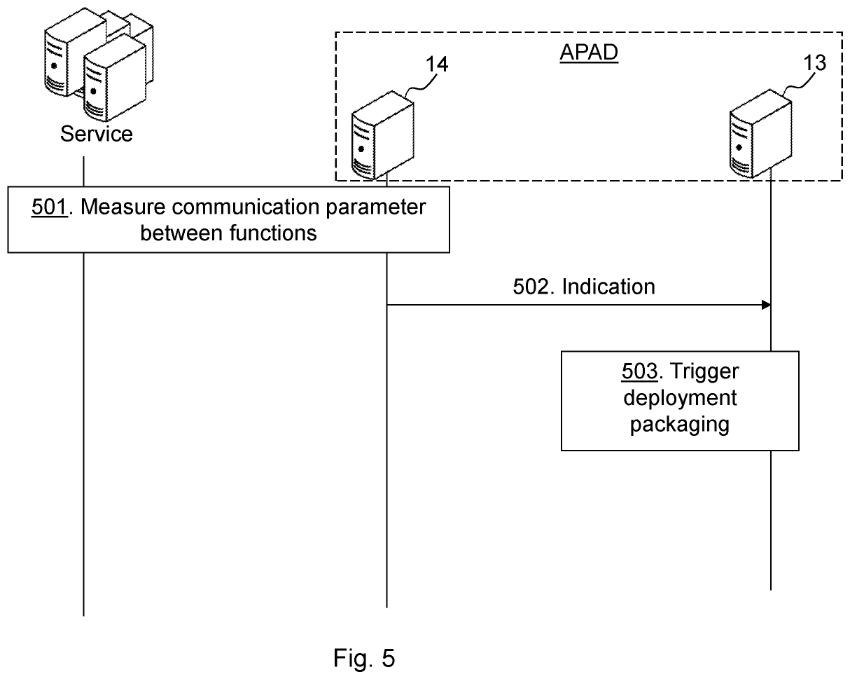

FIG. 5 a is a combined flowchart and signalling scheme depicting embodiments herein.

Action 501. The network node 14, such as an APAD function, measures a parameter related to communications between the functions. The measured parameter may indicate an intensity of traffic between the functions, e.g. packets transmitted between the functions during a time period.

Action 502. The network node 14 may then provide the indication of the measured parameter to the managing node 13.

Action 503. The managing node 13 may then trigger an updating of the deployment packaging based on the indication such as a co-location or separation of functions of the service.

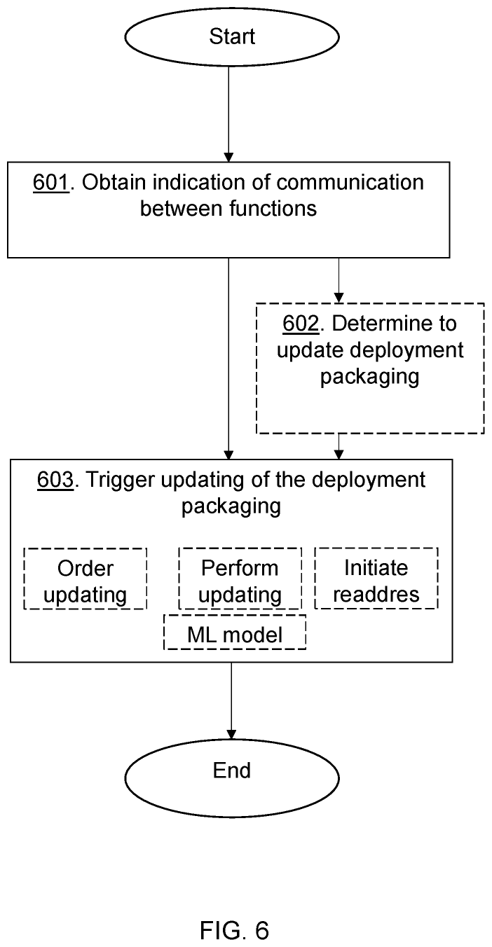

The method actions performed by the managing node 13, such as an orchestrator, for handling the service comprising the functions deployed in the communication network 1 according to embodiments will now be described with reference to a flowchart depicted in FIG. 6. The actions do not have to be taken in the order stated below but may be taken in any suitable order. Dashed boxes indicate optional features.

Action 601. The managing node 13 obtains the indication of the measured parameter related to communications between the functions. For example, the managing node 13 may receive the indication from the network node 14, or may measure the parameter at the managing node 13. The measured parameter may indicate an intensity of traffic, and/or communication cost, between the functions. For example, the measured parameter may be determined frequency of communication between functions. The indication may comprise a value, an index and/or a flag, for example, indicating that the frequency has exceeded a threshold.

Action 602. The managing node 13 may determine to update the deployment packaging. For example, the managing node 13 may determine that the measured parameter indicates a co-location of two or more functions in the communication network. Thus, e.g., when co-locating the functions, the two or more functions may thereby use a shared memory address space. Alternatively, or additionally, the managing node 13 may determine that the measured parameter indicates a separation of two or more functions in the communication network. The managing node 13 may for example determine gains or losses of co-location and/or separation. For example, if two functions are co-located, the latency gain is 2 millisecond, resource usage of the node increases by 3%, and the managing node 13 may determine to recommend a co-location.

Action 603. The managing node 13 triggers the updating of a deployment packaging of the functions based on the obtained indication. The indication may indicate a co-location of two or more functions in the communication network. For example, if the frequency of communication between two functions is above a threshold it may benefit to co-locate the two functions. The indication may indicate a separation of two or more functions in the communication network, for example, in case the traffic intensity is below a threshold. The managing node 13 may trigger the updating of the deployment packaging by ordering redeployment of the functions based on the obtained indication. The managing node 13 may in some examples determine an updated deployment packaging based on the obtained indication and may send instructions to an executing node such as a CI/CD. In an example, at least the indicated measured parameter may be fed into a machine learning (ML) model, e.g., a trained neural network, and the machine learning model may output a result related to the updating of the deployment packaging of the functions, such as, for functions comprising function a, function b, function c and function d, co-locate functions b and d and separate functions a and b. The managing node 13 may trigger the updating by determining and initiating an updated deployment packaging, the updating of the deployment packaging may be performed during run-time of the service. The updating of the deployment packaging may comprise changing a layout of the functions in the communication network 1, for example, the managing node 13 may instruct for a re-deployment of functions that may happen during run-time. The managing node may trigger the updating of the deployment packaging based on the determination in action 602.

The managing node 13 may trigger the updating of the deployment packaging by initiating a re-addressing of packets communicated within the service, which re-addressing is based on the ordered redeployment of the function. Thus, the managing node 13 may handle packets and perform re-addressing, or just inform a node handling packets of the service. The managing node 13 may trigger the updating of the deployment packaging by deploying a proxy domain name server for intercepting one or more queries related to the updated deployment packaging of the functions.

The location of the functions may be stored as a service record, also referred to as an SRV record, in the registry listening to the DNS protocol. Every function instance may have one or more SRV entries in the registry, one for each protocol that may be used to access the service, such as transport control protocol (TCP), user datagram protocol (UDP), etc. It should be noted that the protocols are not limited to use TCP and/or UDP, but may also comprise, e.g., an indication to use a direct memory call instead in case the functions share the same memory space.

Finding a function may be performed by sending an SRV query with a name like ‘_service1._tcp.mycloud.com’, the reply may comprise a list of addresses that may be used to contact the ‘service1’. The order of the address list is significant, since the first address in the reply list is preferred. The registry should put the closest address first and if the requested function is co-located with the querying function a localhost address e.g., ‘127.0.0.1,’ should be placed as the first address in the SRV reply. In this way, the implementation of the functions is unaffected by embodiments herein.

There may be at least two approaches to achieve the above functionality. The first approach utilizes the search directive in the DNS configuration to first query a co-located version of the function instead of a global one. The second approach uses the concept of a DNS proxy, which is an additional function installed to the same image as the co-located functions. The purpose of the DNS proxy is to detect DNS queries for co-located function(s) and respond to the queries on behalf of the DNS server. This eliminates the need to send DNS queries for co-located functions to the DNS server, thus making function discovery even faster by eliminating unnecessary communication. In both cases, the required configuration may be injected into the image, i.e. deployed, when the image is constructed.

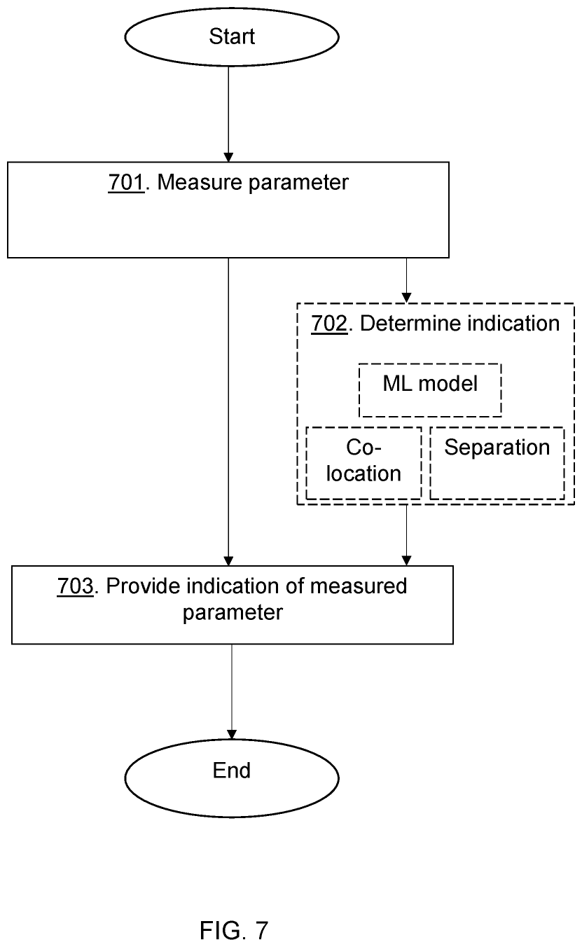

The method actions performed by the network node 14, such as a node analysing the behaviour of the service, for example, a part of an APAD function, for handling the service comprising the functions deployed in the communication network 1 according to embodiments will now be described with reference to a flowchart depicted in FIG. 7. The actions do not have to be taken in the order stated below but may be taken in any suitable order. Dashed boxes indicate optional features.

Action 701. The network node 14 measures the parameter related to communications between the functions. The measured parameter may indicate the intensity of traffic between the functions.

Action 702. The network node 14 may determine that the measured parameter indicates a co-location and/or a separation of functions. For example, the network node 14 may determine that the measured parameter indicates a co-location of two or more functions in the communication network. Thus, the two or more functions may thereby use a shared memory address space. Alternatively, or additionally, the network node 14 may determine that the measured parameter indicates a separation of two or more functions in the communication network. The network node 14 may for example determine gains or losses of co-location and/or separation. For example, if two functions are co-located, the latency gain is 2 millisecond, resource usage of the node increases by 3%, and the network node 14 may indicate a co-location. In some embodiments at least the indicated measured parameter is fed into a machine learning model and the machine learning model outputs the indication.

Action 703. The network node 14 provides to the managing node 13 the indication of the measured parameter. The indication may indicate a co-location and/or a separation of two or more functions in the communication network.

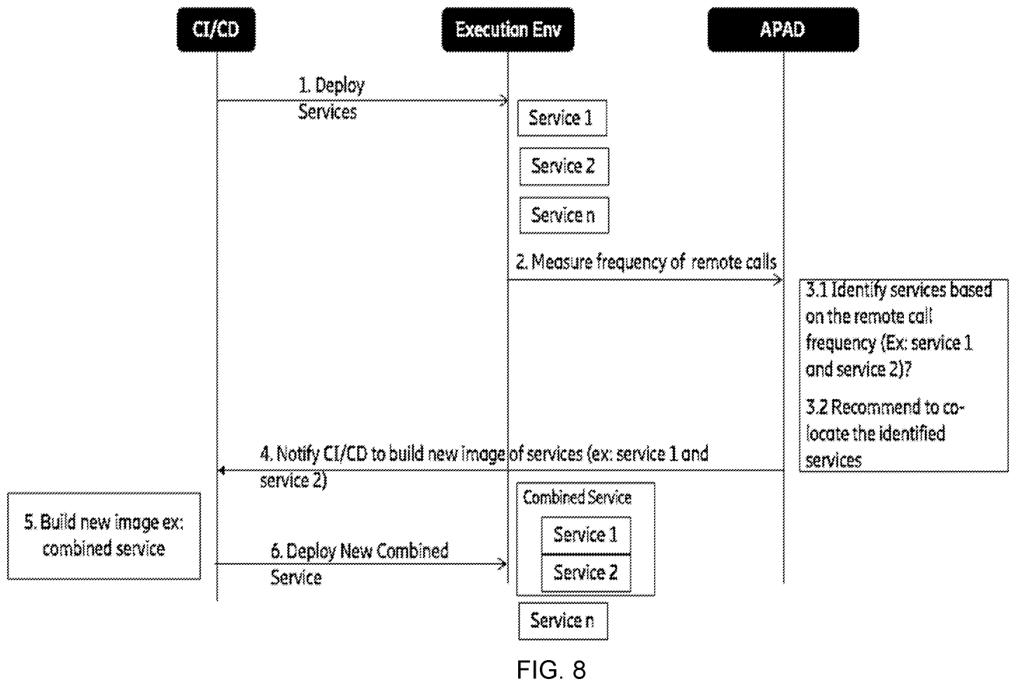

An example illustration of embodiments herein is depicted in FIG. 8. There are three components illustrated, Continuous Integration/Continuous Deployment (CI/CD), execution environment, and the proposed solution denoted as APAD. The CI/CD builds the service images and deploy the functions to the target execution environment, example: mapping functions to containers, virtual machines, as shown in the FIG. 8. For the sake of description, the assumption is that the service comprises n subservices, i.e., functions, named as service 1, service 2, and service n. These functions communicate with each other's. APAD, being an example of a combination of the managing node 13 and the network node 14, measures the frequency of remote calls between the functions, analyses the frequency of remote calls between the functions, and identifies the functions (services) which communicates extensively, for example: service 1 and service 2 communicates over a set threshold during a service. Measurements may be performed, e.g., by kernel hooks (see eBPF), or similar technologies for network traffic probing. Based on this analysis, the APAD may recommend and send a request to the CI/CD to co-locate or separate the functions. The CI/CD builds new function image example “combined service” and repackage and deploys the new “combined service” to the target execution environment as shown in the FIG. 8.

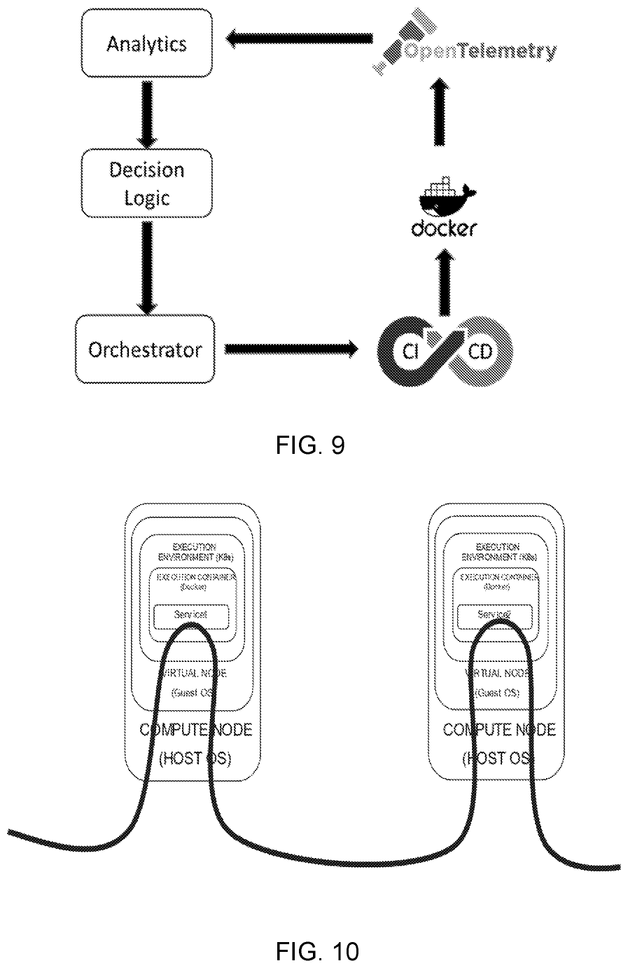

This process of function identification and co-location may be a continuous process (loop) as exemplified in FIG. 9.

Analytics and co-location/separation are run in a continuous process. Measurement of, for example, the traffic intensity between functions is constantly collected and delivered to analytics. When a decision logic gets the information that co-location of two functions would be beneficial an operator is given a request to combine the two functions. The operator may then request the CI/CD to build a new software unit such as a new image, container, or package containing the two functions and execute them. When the new image is in execution the measurement system will start to collect data from new containers of the repackaged service and deliver the data to analytics. Based on the collected data a new decision may be made. Thus, the deployment packaging is dynamically updated.

Note, that in FIG. 9, Docker and OpenTelemetry and mentioned as examples and may be replaced by other container-and observability-solution.

Thus, according to embodiments herein the orchestrator may, at runtime, re-create the deployment packaging based on system probing. Once the managing node 13 such as the orchestrator requests function1 and function2 to be co-located, the CI/CD pipeline will resolve the dependencies and create one container including both functions. The CI/CD pipeline will analyze package manager dependencies as well as for example docker files of both original containers. Using this information, a new container may be created meeting both original containers requirements. The CI/CD pipeline may also add a local service registry proxy that will intercept service location requests, for example DNS requests, and respond with a local address if the request is related to function2.

Thus, measurement data may constantly be delivered from OpenTelemetry, or other observability mechanism, to the analysis, such as the network node 14. Analytics or artificial intelligence (AI) at the network node 14 and/or the managing node 13, may make the decision if and when there is need to co-locate functional components or to separate the co-location. In case there is a benefit in reorganizing the components the operator is requested to perform the reorganization. The managing node may then request the new image from CI/CD and when the new image is ready, managing node will order the upgrade of the image in execution.

Co-location may be executed in steps, according to the procedures described below. In some cases, the orchestration systems may decide to stop at a certain level, and in other cases co-location to the finest granularity is needed. The finest level of co-location is described as the last step in the following description. Other steps are included for completeness.

In distributed systems, functions communicate over whatever network that connects the entities, see FIG. 10 for an example. Within a datacenter, it may be over a switching fabric. In geographically distributed systems, it may be over routed networks. Having a massive number of services in a dis-aggregated architecture, will lead to increased latency due to this traffic.

The first step of co-location is to co-locate functions so, that they reside on the same physical host, as exemplified in FIG. 11. By doing this, inter-functions traffic is avoided. Thus, not using the network interface card (NIC) of the host nor the other networking resources.

This configuration still uses two logical hosts, or two virtual machines. The functions are isolated and “see” each other as if their peer would be on another host.

This may be achieved by orchestration the placement of runtime components and execution environments, as long as the orchestrator has authorities to use the resources of the host. The application does not need to be aware of this changed configuration. The same service may be deployed on different physical hosts and on the same, but different virtual machines without changing the application. Because of this, the application will still need to serialize and secure the traffic between the functions, as it is not aware of the fact that the remote peer is located on the same physical host. Also, traffic between the VMs will cause multiple context switches between user and kernel mode.

In this example configuration, as illustrated in FIG. 12, functions are deployed within the same virtual host, enabling that traffic between then may stay within the VM. The VM detects that traffic is destined for a component deployed within the same VM and may thus prohibit traffic from entering the host operating system (OS). This will decrease the network load and utilization of networking resources. The applications are still not aware that the peer is located on the same host and on the same VM. As in the previous configuration, applications still need to secure and serialize traffic between the services.

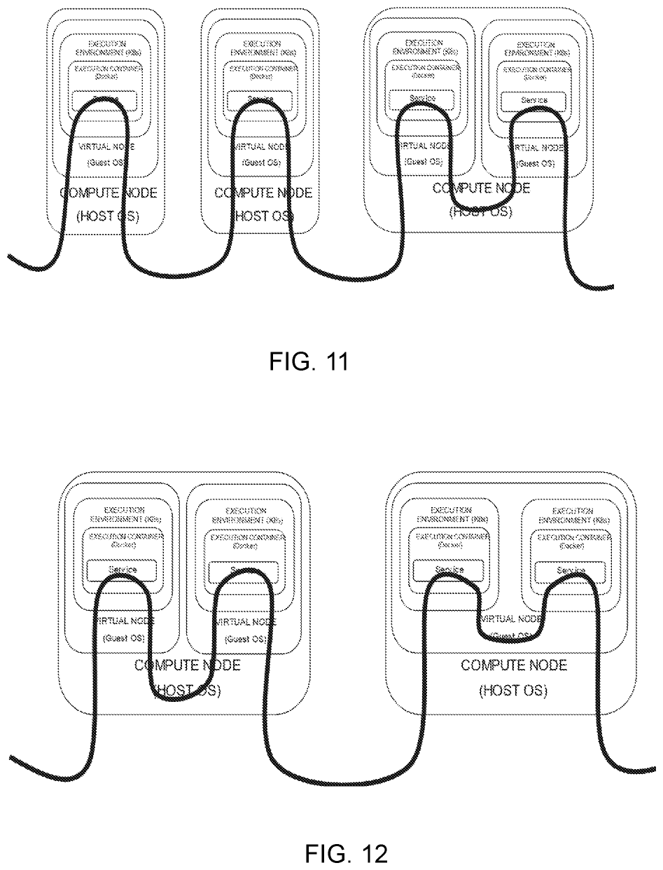

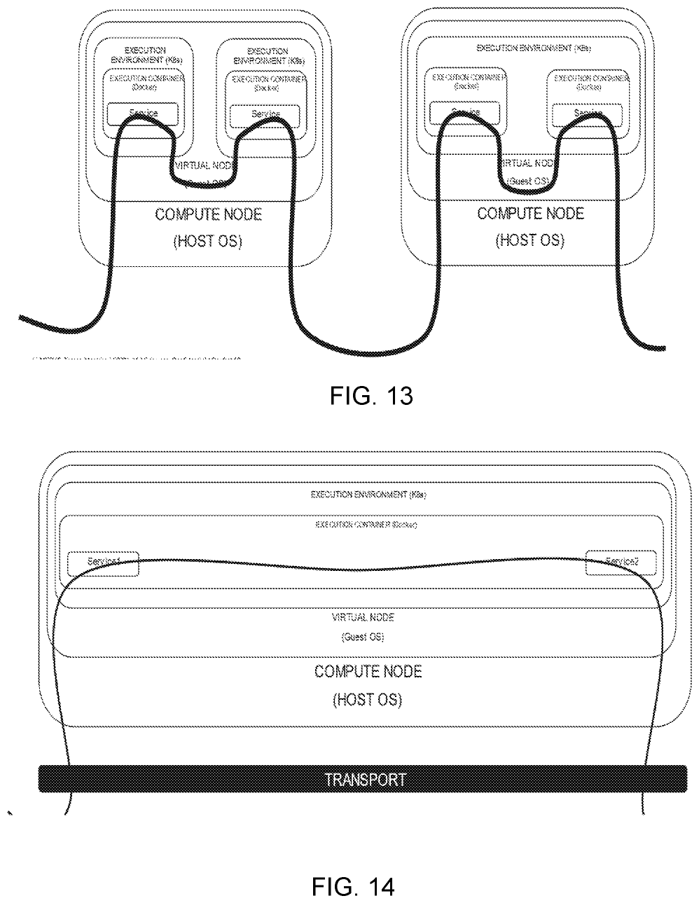

In this example configuration, as illustrated in FIG. 13, the execution container, for example Docker, is placed within the same orchestration domain, for example Kubernetes. This enables the execution environment orchestrator to detect the co-location of these containers and optimize traffic in between. In this case, traffic does not leave the physical host, but still context switching exists as traffic traverses the VM.

External requirements may comprise: Measurement system providing information on resources usage in nodes and execution containers. DevOps system to provide functional component.

Locating the function within the same POD, as exemplified in FIG. 14, which POD is within the same address space enables fast communication between the functions by using address references rather than data transmission. Resulting in zero copy communication. In such configuration, remote calls, for example gRPC, will optimize how data is transmitted between peers.

This configuration requires the application runtime packaging to be aware of which other functions need to be packaged within the same container.

An example with three functions, service1, service2 and service3, is depicted below.

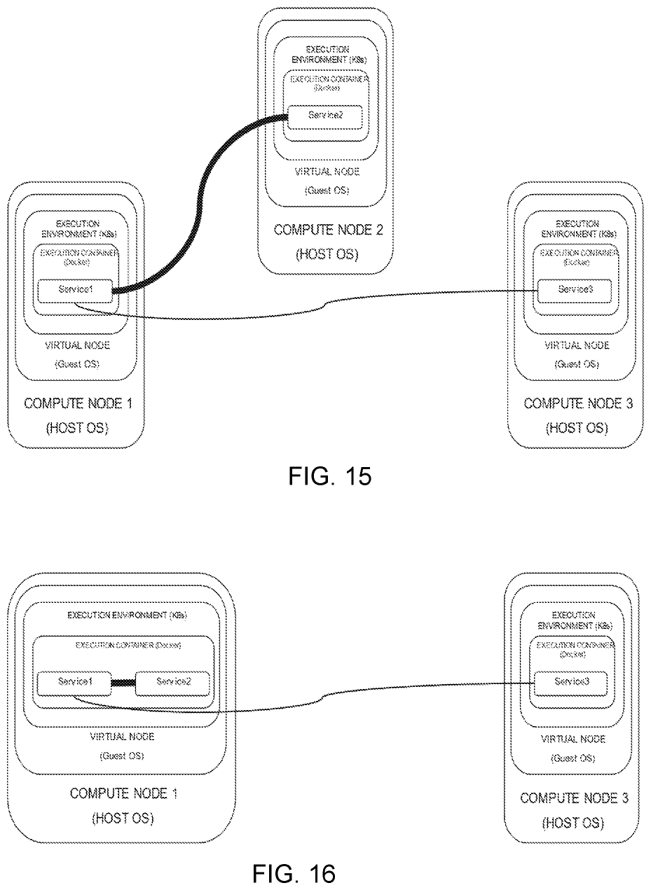

FIG. 15 depicts an example scenario of a current state, where all three function are deployed in separate containers, clusters, VMs and physical hosts. The orchestrator will notice that the traffic level between Service1 and Service2 is high, indicated by the thick line. Consequently, the orchestrator will re-package Service1 and Service2 into one container and place it on Compute Node 1, as depicted in an example scenario in FIG. 16. This may be since it is close to the service consumer. There may also be some traffic between Service1 and Service3, but the orchestrator may decide that this traffic is not significant enough to motivate co-location of Service1 and Service3.

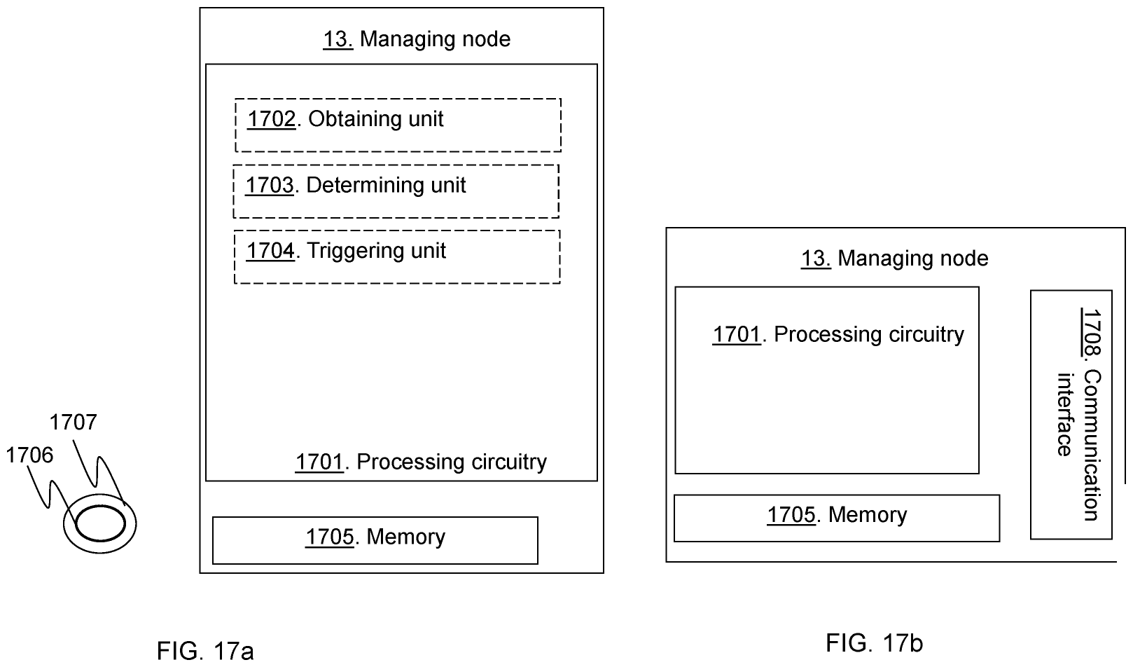

FIG. 17a and FIG. 17b depict in a block diagram manner two different examples of the managing node 13, for example, an orchestrator, for handling the service comprising functions deployed in the communication network.

The managing node 13 may comprise processing circuitry 1701, e.g., one or more processors, configured to perform the methods herein.

The managing node 13 may comprise an obtaining unit 1702, e.g., a receiver or a transceiver. The managing node 13, the processing circuitry 1701 and/or the obtaining unit 1702 is configured to obtain the indication of the measured parameter related to communications between the functions. The measured parameter may indicate intensity of traffic, and/or communication cost, between the functions. The indication may indicate the co-location of the two or more functions in the communication network. The indication may indicate a separation of two or more functions in the communication network. The managing node 13, the processing circuitry 1701 and/or the obtaining unit 1702 may be configured to obtain the indication of the measured parameter by receiving the indication from a network node, or by measuring the parameter at the managing node.

The managing node 13 may comprise a determining unit 1703. The managing node 13, the processing circuitry 1701 and/or the determining unit 1703 may be configured to determine that the measured parameter indicates a co-location of two or more functions in the communication network. The managing node 13, the processing circuitry 1701 and/or the determining unit 1703 may be configured to determine that the measured parameter indicates a separation of two or more functions in the communication network.

The managing node 13 may comprise a triggering unit 1704, e.g., a transmitter or a transceiver. The managing node 13, the processing circuitry 1701 and/or the triggering unit 1704 is configured to trigger the updating of the deployment packaging of the functions based on the obtained indication. The managing node 13, the processing circuitry 1701 and/or the triggering unit 1704 may be configured to trigger the updating of the deployment packaging by ordering redeployment of the functions based on the obtained indication. The managing node 13, the processing circuitry 1701 and/or the triggering unit 1704 may be configured to trigger the updating of the deployment packaging by initiating a re-addressing of packets communicated within the service, which re-addressing is based on the ordered redeployment of the functions. The managing node 13, the processing circuitry 1701 and/or the triggering unit 1704 may be configured to trigger the updating of the deployment packaging by deploying the proxy domain name server for intercepting the one or more queries related to the updated deployment packaging of the functions. The managing node 13, the processing circuitry 1701 and/or the triggering unit 1704 may be configured to use the machine learning model and at least the indicated measured parameter is fed into the machine learning model and the machine learning model outputs the result related to the updating of the deployment packaging of the functions. The managing node 13, the processing circuitry 1701 and/or the triggering unit 1704 may be configured to trigger the updating of the deployment packaging during run-time of the service. The managing node 13, the processing circuitry 1701 and/or the triggering unit 1704 may be configured to trigger the updating of the deployment packaging by changing layout of the functions in the communication network. The managing node 13, the processing circuitry 1701 and/or the triggering unit 1704 may be configured to trigger the updating of the deployment packaging based on the determination above.

The managing node 13 may comprise a memory 1705. The memory 1705 comprises one or more units to be used to store data on, such as data packets, processing time, measured parameters, indications, orders, measurements, events and applications to perform the methods disclosed herein when being executed, and similar. Furthermore, the managing node 13 may comprise a communication interface 1708 such as comprising a transmitter, a receiver, a transceiver and/or one or more antennas.

The methods according to the embodiments described herein for the managing node 13 are respectively implemented by means of e.g., a computer program product 1706 or a computer program, comprising instructions, i.e., software code portions, which, when executed on at least one processor, cause the at least one processor to carry out the actions described herein, as performed by the managing node 13. The computer program product 1706 may be stored on a computer-readable storage medium 1707, e.g., a disc, a universal serial bus (USB) stick or similar. The computer-readable storage medium 1707, having stored thereon the computer program product, may comprise the instructions which, when executed on at least one processor, cause the at least one processor to carry out the actions described herein, as performed by the managing node 13. In some embodiments, the computer-readable storage medium may be a transitory or a non-transitory computer-readable storage medium. Thus, embodiments herein may disclose a managing node 13 for handling a service comprising functions deployed in a communication network, wherein the managing node 13 comprises processing circuitry and a memory, said memory comprising instructions executable by said processing circuitry whereby said managing node 13 is operative to perform any of the methods herein.

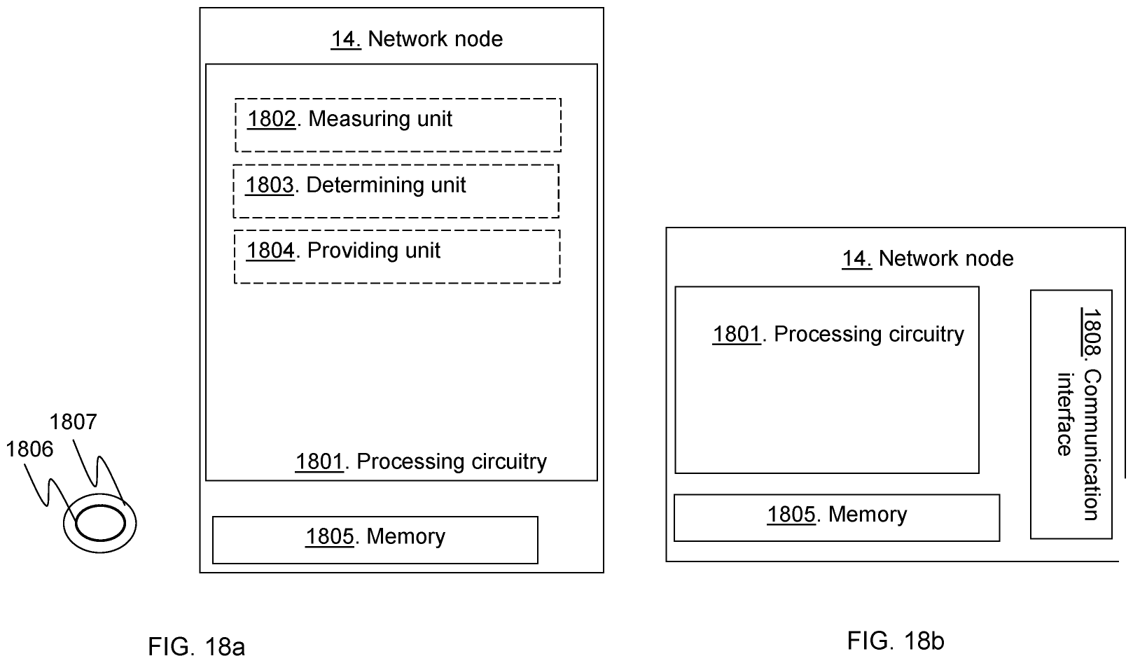

FIG. 18a and FIG. 18b depict in a block diagram manner two different examples of the network node 14, such as an analysing node or a part of the APAD function, for handling the service comprising functions deployed in the communication network 1.

The network node 14 may comprise processing circuitry 1801, e.g., one or more processors, configured to perform the methods herein.

The network node 14 may comprise a measuring unit 1802. The network node 14, the processing circuitry 1801 and/or the measuring unit 1802 is configured to measure the parameter related to the communications between the functions. The measured parameter may indicate the intensity of traffic between the functions.

The network node 14 may comprise a determining unit 1803. The network node 14, the processing circuitry 1801 and/or the determining unit 1803 may be configured to determine that the measured parameter indicates a co-location and/or a separation of two or more functions in the communication network.

The network node 14 may comprise a providing unit 1804, e.g., a transmitter or a transceiver. The network node 14, the processing circuitry 1801 and/or the providing unit 1804 is configured to provide to the managing node the indication of the measured parameter. The indication may indicate a co-location and/or a separation of two or more functions in the communication network. The network node 14, the processing circuitry 1801 and/or the determining unit 1803 may be configured to determine that the measured parameter indicates the co-location of two or more functions in the communication network; and the indication provided indicates such a co-location. The network node 14, the processing circuitry 1801 and/or the determining unit 1803 may be configured to determine that the measured parameter indicates the separation of two or more functions in the communication network; and the indication provided indicates such a separation.

The network node 14, the processing circuitry 1801 and/or the providing unit 1804 may be configured to use the machine learning model and at least the indicated measured parameter is fed into the machine learning model and the machine learning model outputs the indication.

The network node 14 may comprise a memory 1805. The memory 1805 comprises one or more units to be used to store data on, such as data packets, measured parameters, indications, ML model, measurements, events and applications to perform the methods disclosed herein when being executed, and similar. Furthermore, the network node 14 may comprise a communication interface 1808 such as comprising a transmitter, a receiver, a transceiver and/or one or more antennas.

The methods according to the embodiments described herein for the network node 14 are respectively implemented by means of e.g., a computer program product 1806 or a computer program, comprising instructions, i.e., software code portions, which, when executed on at least one processor, cause the at least one processor to carry out the actions described herein, as performed by the network node 14. The computer program product 1806 may be stored on a computer-readable storage medium 1807, e.g., a disc, a universal serial bus (USB) stick or similar. The computer-readable storage medium 1807, having stored thereon the computer program product, may comprise the instructions which, when executed on at least one processor, cause the at least one processor to carry out the actions described herein, as performed by the network node 14. In some embodiments, the computer-readable storage medium may be a transitory or a non-transitory computer-readable storage medium. Thus, embodiments herein may disclose a network node 14 for handling the service comprising functions in the communication network, wherein the network node 14 comprises processing circuitry and a memory, said memory comprising instructions executable by said processing circuitry whereby said network node 14 is operative to perform any of the methods herein.

In some embodiments a more general term “network node” is used and it may correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, Remote Radio Unit (RRU), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless device or user equipment (UE) is used and it refers to any type of wireless device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However, the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a managing node for handling a service comprising functions deployed in a communication network, the method comprising:
obtaining an indication of a measured parameter related to communications between the functions; and
triggering an updating of a deployment packaging of the functions based on the obtained indication.

2. The method according to claim 1, wherein triggering the updating of the deployment packaging comprises ordering redeployment of the functions based on the obtained indication.

3. The method according to claim 2, wherein triggering the updating of the deployment packaging further comprises initiating a re-addressing of packets communicated within the service, which re-addressing is based on the ordered redeployment of the functions.

4. The method according to claim 1, wherein triggering the updating of the deployment packaging comprises deploying a proxy domain name server for intercepting one or more queries related to the updated deployment packaging of the functions.

5. The method according to claim 1, wherein the measured parameter indicates intensity of traffic, and/or communication cost, between the functions.

6. The method according to claim 1, wherein the indication indicates a co-location of two or more functions in the communication network.

7. The method according to claim 1, wherein the indication indicates a separation of two or more functions in the communication network.

8. The method according to claim 1, wherein at least the indicated measured parameter is fed into a machine learning model and the machine learning model outputs a result related to the updating of the deployment packaging of the functions.

9. The method according to claim 1, wherein the functions comprise one or more of microservices, micro functions, components, subservices and subfunctions.

10. The method according to claim 1, wherein obtaining the indication of the measured parameter comprises receiving the indication from a network node, or measuring the parameter at the managing node.

11. The method according to claim 1, wherein triggering the updating of the deployment packaging one or both:
is performed during run-time of the service; and
comprises changing layout of the functions in the communication network.

12. (canceled)

13. The method according to claim 1 further comprising one or both:
determining that the measured parameter indicates a co-location of two or more functions in the communication network and triggering the updating of the deployment packaging is based on the determination; and
determining that the measured parameter indicates a separation of two or more functions in the communication network and triggering the updating of the deployment packaging is based on the determination.

14. (canceled)

15. A method performed by a network node for handling a service comprising functions deployed in a communication network, the method comprising:
measuring a parameter related to communications between the functions; and
providing to a managing node an indication of the measured parameter.

16. The method according to claim 13, wherein one or both:
the measured parameter indicates one or both intensity and communication cost, of traffic between the functions; and
the indication indicates one or both of a co-location and a separation of two or more functions in the communication network.

17. (canceled)

18. The method according to claim 15, further comprising one or both:
determining that the measured parameter indicates a co-location of two or more functions in the communication network; and the indication provided indicates such a co-location; and
determining that the measured parameter indicates a separation of two or more functions in the communication network; and the indication provided indicates such a separation.

19. (canceled)

20. The method according to claim 13, wherein at least the indicated measured parameter is fed into a machine learning model and the machine learning model outputs the indication.

21. (canceled)

22. A computer-readable storage medium, having stored thereon a computer program product comprising instructions which, when executed on at least one processor, cause the at least one processor to carry out a method for handling a service comprising functions deployed in a communication network, the method comprising:
obtaining an indication of a measured parameter related to communications between the functions; and
triggering an updating of a deployment packaging of the functions based on the obtained indication.

23. A managing node for handling a service comprising functions deployed in a communication network, wherein the managing node is configured to:
obtain an indication of a measured parameter related to communications between the functions; and
trigger an updating of a deployment packaging of the functions based on the obtained indication.

24.-36. (canceled)

37. A network node for handling a service comprising functions deployed in a communication network, the network node being configured to:
measure a parameter related to communications between the functions; and
provide to a managing node an indication of the measured parameter.

38.-42. (canceled)
